(19) United States
(12) Patent Application Publication
(10) Pub. No.: US 2006/0102262 A1
(43) Pub. Date: May 18, 2006

(54) Heat protective coverings and method for use thereof

(76) Inventor: Robert Rodrigues, Glendale, AZ (US)

Correspondence Address: WEISS & MOY PC, 4204 NORTH BROWN AVENUE, SCOTTSDALE, AZ, 85251, US

(21) Appl. No.: 10/992,243

(22) Filed: Nov. 18, 2004

(51) Int. Cl. B65D 65/02; H01B 17/34

(52) U.S. Cl. 150/158

(57) ABSTRACT

A heat protective covering includes a heat-resistant flexible sheet for wrapping around an article that retains heat and interlocking fastening s to secure the wrapped sheet around the article. One part of the interlocking fastening s may be on the article itself. The sheet may define one or more notches to accommodate the contours of the article. The sheet may be defined as a pocket for the article. The heat protective covering may be used for any article that retains heat such as seat belt buckles, outdoor furniture, pool ladders, shopping carts, handles, etc. to substantially prevent burns caused by touching or otherwise contacting the article. The method of using the heat protective coverings is also provided.

### FIELD OF THE INVENTION

The present invention relates generally to heat protective coverings that aid in the substantial prevention of burns caused by touching or otherwise contacting surfaces that retain heat when exposed to high temperatures. More specifically, this invention relates to a heat protective covering that securely wraps around the affected surface to provide a barrier from the heat.

### BACKGROUND OF THE INVENTION

During scorching hot weather, certain article surfaces when exposed to the sun can become sufficiently hot to cause burns upon touch or other contact. This poses a special hazard to people and pets. For example, vinyl seats and metal hardware in automobiles heated by the sun can seriously burn skin. Other susceptible articles include outdoor furniture and play equipment, seat belts, steering wheels, gear shifts, barbecue and door handle 14 as, shopping carts, etc. These articles may become too hot to handle when exposed to high temperatures during hot weather periods.

Individuals with prior awareness of this danger may seek to shelter the articles in shade but no shade may be available or the article may not be feasibly moved or located in a shady area. They may choose to place a physical barrier over the article, for example covering the article, only to find the cover moved upon their return. An individual may choose to wear protective clothing such as gloves or the like. However, this protective clothing may be uncomfortable, especially during hot weather. None of these approaches is entirely satisfactory.

Accordingly, there exists a need for heat protective coverings that are substantially heat resistant, that can be readily adapted for a variety of articles, substantially remain in place, and are easy and convenient to use whenever necessary. There is also a need for heat protective coverings that are substantially water resistant for wet environments. The present invention fulfills these needs and provides further related advantages.

### SUMMARY OF THE INVENTION

According to the present invention and exemplary embodiments thereof described herein, heat protective coverings are provided for use in substantially preventing burns caused by touching or otherwise contacting an article that retains heat. The covering generally comprises a substantially heat-resistant and flexible sheet for wrapping around at least one heat-exposed surface of an article and fastening elements to secure the wrapped sheet around the at least one heat-exposed surface. The sheet may further include one or more notches in spaced relationship to each other along at least one portion of the flexible sheet to accommodate bends and curves in the article as hereinafter described.

The flexible sheet may be substantially heat resistant with low thermal conductivity permitting the sheet to be exposed over time to heat without a substantial increase in its temperature or the temperature of the covered portion of the article. The preferred material may withstand temperatures of up to about 180 degrees Fahrenheit and may be substantially resistant to melting or warping. The sheet may be flexible with sufficient elasticity to be able to wrap or bend around articles.

The one or more notches along the at least one portion of the article are preferably along the edges of the heat protective covering in spaced relation to each other. The one or more notches enable the covering to be wrapped around corners, bends, or other obstructions of the article without substantial bunching.

The fastening elements may be in spaced relationship along one or more edges for manually attachable and detachable interlocking engagement with complementary fastening elements on the opposite edge of the reverse side of the flexible sheet so that when wrapped around at least a portion of the heat-retaining article, the heat protective covering can be secured by attaching the interlocking fastening elements.

In another form of the invention, the flexible sheet may be wrapped around circular articles such as round table rims, steering wheels, etc. Alternatively, the flexible sheet may be formed into a continuous circumferential covering.

In still another form of the invention, the heat protective covering defined as a pocket may be used over handles or seat belt buckles. The pocket may be formed from the flexible sheet or molded from plastic into a substantially rigid pocket that receives the handle or seat belt bucket. The rigid pocket may be covered by the flexible sheet material.

The method for substantially protecting against burns caused by touching or otherwise contacting a surface of an article exposed to heat is also provided.

Other features and advantages of the invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of an exemplary heat protective covering embodying the novel features of the invention, illustrating a plurality of notches along the longitudinal edges of the heat protective covering and hook and loop fastening elements for securing the heat protective covering around at least a portion of an article;

FIG. 1A is another exemplary embodiment of the invention similar to FIG. 1, illustrating snaps instead of hook and loop fastening elements for securing the heat protective covering around at least a portion of an article;

FIG. 2 is an environmental perspective view illustrating the heat protective covering of FIG. 1A wrapped and secured over the top rungs of an exemplary lawn chair back and around a portion of one of the chair legs;

FIG. 2A is similar to FIG. 2 illustrating the heat protective covering wrapped and secured around all the rungs of the lawn chair back and over one of the chair arms;

FIG. 3 is a perspective view of a table with an exemplary heat protective covering wrapped around an edge of the table;

FIG. 3A is a fragmented perspective view of the table of FIG. 3, illustrating the provision of snaps along an edge of the heat protective covering for securing the heat protective covering to a corresponding fastening element on the underside of the table;

FIG. 4 is a perspective view of an exemplary bench with the heat protective covering wrapped and secured around the seat thereof, illustrating one or more of the plurality of notches providing accommodation for the bench legs;

FIG. 5 is an assembly view of an exemplary door handle received into another exemplary heat protective covering defined in the shape of a pocket;

FIG. 5A is a perspective view of the heat protective covering of FIG. 5, illustrating in dotted lines the door handle within the heat protective covering;

FIG. 6 is a partial environmental perspective view of another door handle on a door (shown in dotted lines) around which the heat protective covering is wrapped and secured, with a portion of the heat protective covering not secured to show opposed hook and loop fastening elements;

FIG. 7 is an assembly view of a latch housing of a seat belt buckle being received into another exemplary heat protective covering;

FIG. 7A is a perspective view of the heat protective covering of FIG. 7, illustrating in dotted lines the latch housing within the heat protective covering;

FIG. 7B is a perspective view of a seat belt buckle latch tongue;

FIG. 7C is an assembly view of an exemplary heat protective covering for the seat belt buckle latch tongue of FIG. 7B, illustrating fastening of the heat protective covering around the latch tongue using hook and loop fastening elements; and

FIG. 7D is an assembly view similar to FIG. 7C, illustrating fastening of the covering around the latch tongue using snap fastening elements.

### DETAILED DESCRIPTION OF THE PREFERRED EMBODIMENTS

As shown in the drawings for purposes of illustration, the present invention is concerned with a heat protective covering referred to generally in the accompanying drawings by the reference number 10. The method for using the heat protective covering is also provided. The heat protective covering comprises, generally, a substantially heat-resistant and flexible sheet 12 for wrapping around at least one heat-exposed surface of an article (e.gs. 14a-14f) and fastening elements 16a and/or 16b to secure the wrapped sheet 12 around the at least one heat-exposed surface. The sheet 12 may further define one or more notches 18 in spaced relationship to each other along at least one portion of the flexible sheet 12 to accommodate bends and curves in the article as hereinafter described.

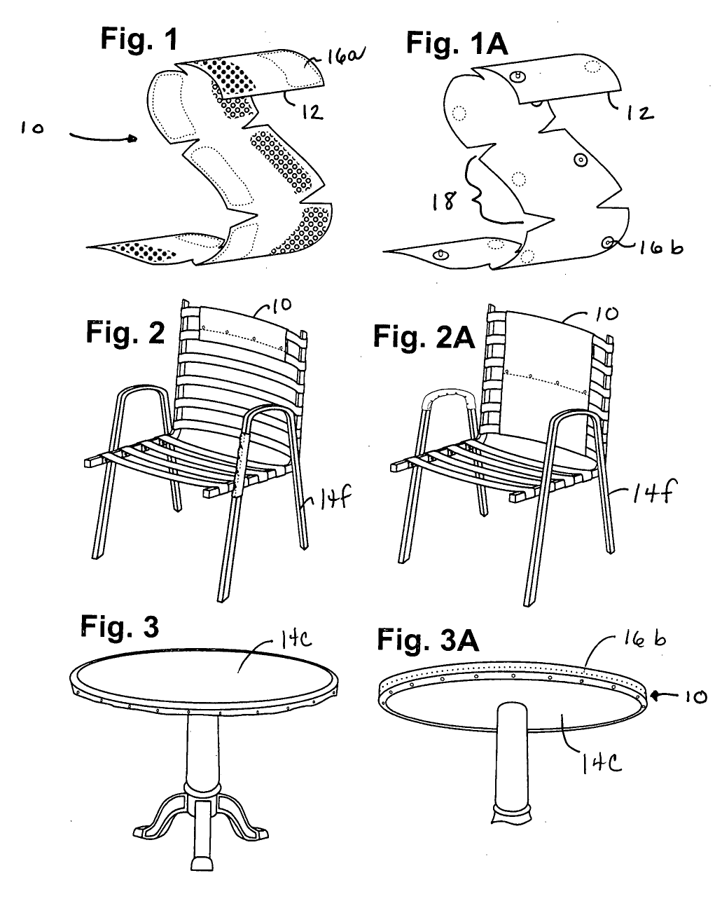

In accordance with the present invention, and as illustrated with respect to preferred embodiments in FIGS. 1-7D, the heat protective coverings provide a substantially effective and secure barrier against direct contact or touch of the affected surface thereby substantially eliminating hazardous burns. The heat protective coverings 10 are easy and convenient to carry so that they may be readily available when needed and easy to use on a variety of articles. The heat protective coverings are a substantially effective tool for heat protection.

The flexible sheet 12 may be substantially heat resistant with low thermal conductivity permitting the sheet to be exposed over time to heat without a substantial increase in its temperature or the temperature of the covered portion of the article. The preferred material may withstand temperatures of up to about 180 degrees Fahrenheit and may be substantially resistant to melting or warping. The sheet may be flexible with sufficient elasticity to be able to stretch, wrap and bend around articles. Suitable materials include polyurethane, latex, or the like.

In a preferred embodiment, the flexible sheet 12 may be preferably substantially rectangular as shown in FIGS. 1 and 1A, although other shapes are contemplated within the confines of the invention. The heat protective covering may be sized depending upon its intended use with varying lengths and widths. For example, the covering for a door handle 14a should be sufficiently sized to provide a barrier between the hand and the handle 14a. As shown in FIGS. 5, 5A, and 6, the heat protective covering 10 may be sized to cover substantially all the gripping surface of a handle 14a. In a preferred form, the material may be substantially water resistant for use where there is potential water exposure, for example, outdoor furniture. This also enables the article including the heat protective covering 10 to be easily cleaned. The material may be substantially lightweight to enable convenient carrying.

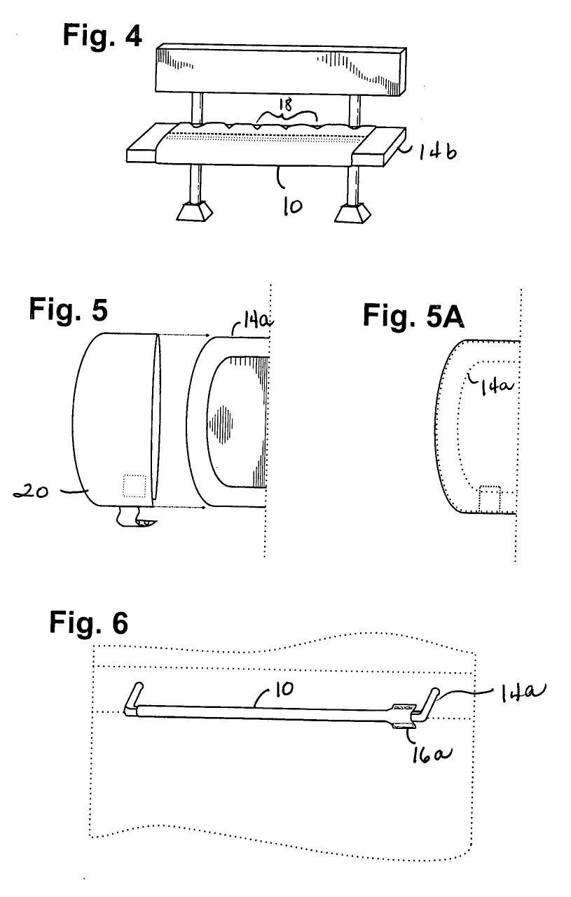

As shown in FIGS. 1 and 1A, the one or more notches 18 along the at least one portion of the article are preferably along the longitudinal edges of the heat protective covering in spaced relation to each other. The one or more notches 18 substantially enable the covering to be wrapped around corners, bends, or other obstructions of the article without substantial bunching. For example, as shown in FIG. 4, the notches accommodate the legs of a bench 14b. In a preferred form, the one or more notches 18 may be included along the longitudinal edges of the covering, although other placements are included. The notches are preferably V-shaped as shown in FIGS. 1, 1A, and 4 or U-shaped, although other shaped notches may be included. The one or more notches 18 substantially increase the flexibility in wrapping the heat protective covering 10 around a variety of articles.

The flexible sheet 12 may include the fastening elements 16a and/or 16b in spaced relationship along one or more edges for manually attachable and detachable interlocking engagement with complementary fastening elements on the opposite edge on the reverse side of the flexible sheet 12 so that when wrapped around at least a portion of the heat-retaining article, the heat protective covering can be secured by attaching the interlocking fastening elements. The fastening elements 16 may include cooperative fastening elementss such as hoop and loop tape (16a), snaps (16b), buttons (not shown) or the like to secure the wrapped covering around at least a portion of the article. The placement of the fastening elements 16a and/or 16b depends upon the intended use of the covering, but the covering generally includes a female part of the fastening element on one edge of the flexible sheet 12 and a male part of the fastening element on the opposite edge on the reverse side of the flexible sheet 12.

In another form of the invention, the heat protective covering 10 may be circumferential to fit around circumferential articles such as the rims of round tables (14c) as shown in FIGS. 3 and 3A, steering wheels and the like. The flexible sheet 12 may be in one continuous circle that stretches around the circumferential article or may be wrapped around the rim of the table 14c with its ends secured together to form the circle. Either of the female or male part of the fastening elements 16a and/or 16b may be on the table 14c itself rather than having both the female and male parts of the fastening elements on the heat protective covering. As shown in FIGS. 3 and 3A, the covering may extend around the table rim and be secured by the corresponding fastening element on the underside of the table.

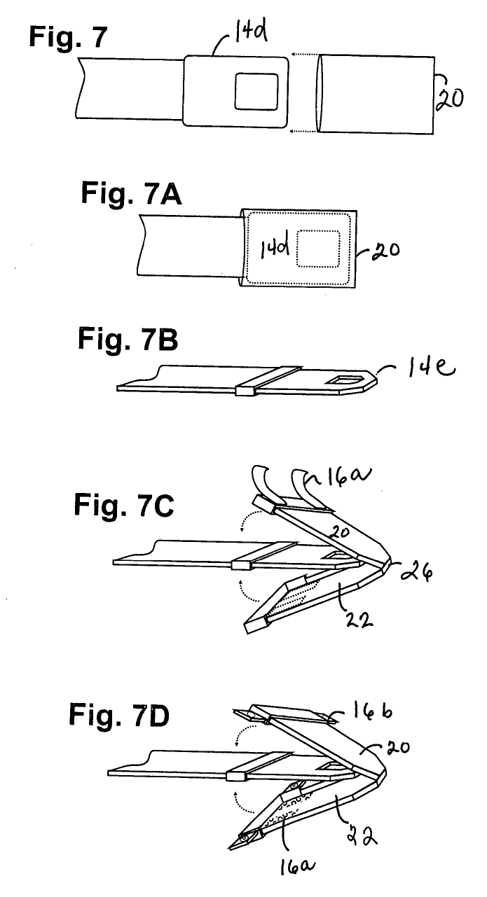

In still another form of the invention, the heat protective covering defines a pocket 20 for use over a door handle 14a (FIGS. 5 and 5A) or a seat belt latch housing 14d (FIGS. 7 and 7A) as hereinafter described. The pocket 20 may be formed from the flexible sheet 12 or molded from plastic into a substantially rigid pocket that receives the handle 14a or seat belt latch housing 14d. The rigid pocket may be covered by the flexible sheet material. The pocket 20 may include fastening elements extending therefrom to secure the pocket around the article as shown in FIG. 5. Hook and loop fastening elements 16a or the like may be used to secure the pocket 20 over the door handle 14a as shown in FIG. 5A.

In another form of the invention as shown in FIGS. 7-7D, the heat protective covering 10 may be used for a latch tongue 14e of an unbuckled seat belt buckle. Seat belts typically include a latch tongue 14e (FIG. 7B) fixed to one seat belt segment and a latch housing 14d fixed to the other seat belt segment. One form of the heat protective covering for seat belt buckles comprises a pocket 20 structured to fit over the seat belt latch housing 14d as shown in FIGS. 7 and 7A. The pocket may also be used to fit over the seat belt latch tongue 14e (not shown). Still another form of the heat protective covering comprises one or more flexible sheets 12 defining a top side 22 and a bottom side 24 to respectively overlie and underlie the latch tongue 14e and a juncture 26 therebetween. The juncture 26 between the top side 22 and the bottom side 24 may be formed by joining two sheets 12 together by any known means or by folding the flexible sheet 12. As shown in FIG. 7C, the substantially heat-resistant flexible sheet 12 may be folded in substantially half to form the juncture 26 between the top side 22 and the bottom side 24 of the heat protective covering 10. The one or more flexible sheets 12 may be substantially V-shaped to substantially follow the outside edge contours of the seat belt latch tongue 14e. To fit over the seat belt latch tongue 14e as shown in FIGS. 7C and 7D, the free end of the latch tongue 14e is fitted into the fold of the flexible sheet 12 with the flexible sheet wrapping around the free end of the latch tongue. A pair of cooperative or complementary fastening elements 16a and/or 16b on the top and bottom sides of the heat protective covering shown in FIGS. 7C and 7D engage with each other to secure the covering 10 over the seat belt latch tongue 14e. FIG. 7C shows the use of hook and loop fastening elements 16a and FIG. 7D shows the use of snapping fastening elements 16b.

The articles may be any article that retains heat when exposed to high temperatures. Such articles are typically constructed of metal, although other materials retain heat when exposed to high temperatures. As shown in the drawings by example, exemplary articles include, but are not limited to, door handles 14a, benches 14b, tables 14c, seat belt buckle housings 14d and latch tongues 14e, and chairs 14f. Other hot surfaces from which an individual may be protected include, but are not limited to, other outdoor furniture and play equipment, steering wheels, gear shifters, barbecue handles, pool ladders, shopping carts, etc.

The method for substantially protecting against burns caused by touching or otherwise contacting a surface of an article exposed to heat is also provided, comprising the steps of wrapping a heat-resistant flexible sheet 12 around at least a portion of the article exposed to heat, the heat-resistant flexible sheet 12 defining one or more notches 18; and securing the heat-resistant flexible sheet 12 around the at least a portion of the article exposed to heat by manually attaching interlocking fastening elements with complementary fastening elements.

In use thereof, the heat protective covering is wrapped around the surface of an article exposed to heat. If the heat protective covering defines the one or more notches 18, the covering 10 may be wrapped such that the one or more notches 18 may be positioned in an area that the body does not typically touch. For example, as shown in FIG. 2A, the one or more notches 18 are positioned at the underside of the chair arm and in FIG. 4, the one or more notches 18 are at the very rear of the bench, areas not typically contacted by a seated individual. The wrapped heat protective covering is then secured by manually attaching corresponding fastening elements. The heat protective covering may be removed from the article by detaching the corresponding fastening elements. The heat protective coverings may be reused if maintained in satisfactory condition.

From the foregoing, it is to be appreciated that the heat protective covering may be adapted for use on any article exposed to substantially prevent burns caused by touching or otherwise contacting such articles, a real problem in particularly hot climates.

Although a particular embodiment of the invention has been described in detail for purposes of illustration, various modifications may be made without departing from the spirit and scope of the invention. Accordingly, the invention is not to be limited, except as by the appended claims.

I claim:

1. A heat protective covering comprising:
a substantially heat-resistant flexible sheet for wrapping around at least a portion of an article that retains heat; and
fastening elements to secure the flexible sheet around the at least a portion of the article.

2. The heat protective covering of claim 1, wherein the substantially heat-resistant flexible sheet is selected from the group comprising polyurethane and latex.

3. The heat protective covering of claim 1, wherein said substantially heat-resistant flexible sheet defines one or more notches in spaced relation along one or more portions of the heat-resistant flexible sheet.

4. The heat protective covering of claim 3, wherein the substantially heat-resistant flexible sheet defines the one or more notches along the longitudinal edges of the heat-resistant flexible sheet.

5. The heat protective covering of claim 4, wherein the one or more notches are substantially V-shaped.

6. The heat protective covering of claim 1, wherein said substantially heat-resistant flexible sheet defines a pocket into which the at least a portion of the article is received.

7. The heat protective covering of claim 1, wherein the fastening elements include interlocking fastening elements for manually attachable and detachable engagement with complementary fastening elements.

8. The heat protective covering of claim 7, wherein said fastening elements include interlocking hook and loop fastening elements.

9. The heat protective covering of claim 7, wherein said fastening elements include interlocking snapping fastening elements.

10. The heat protective covering of claim 1, wherein said flexible sheet defines a circumferential wrap.

11. The heat protective covering of claim 7, wherein said complementary fastening elements are on the article.

12. The heat protective covering of claim 1, wherein one or more of the substantially heat-resistant flexible sheets define a top sheet and a bottom sheet to respective overlie and underlie a seat belt latch tongue, a free end of the latch tongue received at a juncture between the top and bottom sheets.

13. A heat protective covering, comprising:
a substantially rectangular heat-resistant flexible sheet for wrapping around at least one heat exposed surface of an article exposed to heat, the substantially heat-resistant flexible sheet defining one or more notches along the longitudinal edges of the substantially heat-resistant flexible sheet to substantially prevent bunching thereof as a result of wrapping; and
interlocking fastening elements for manually attachable and detachable engagement with complementary fastening elements for securing the substantially rectangular heat-resistant flexible sheet around the at least one heat exposed surface to substantially protect against burns caused by touching the at least one heat exposed surface of an article.

14. The heat protective covering of claim 13, wherein the substantially heat-resistant flexible sheet is selected from the group comprising polyurethane and latex.

15. The heat protective covering of claim 13, wherein the one or more notches are in spaced relation along one or more portions of the heat-resistant flexible sheet.

16. The heat protective covering of claim 15, wherein the one or more notches are along the longitudinal edges of the heat-resistant flexible sheet.

17. The heat protective covering of claim 16, wherein the one or more notches are substantially V-shaped.

18. The heat protective covering of claim 18, wherein said interlocking fastening elements are on an opposite edge on the reverse side of the substantially rectangular heat-resistant flexible sheet.

19. A heat protective covering, comprising a substantially rigid, heat resistant molded plastic pocket for receiving at least a portion of a heat-retaining article.

20. A method for substantially protecting against burns caused by touching or otherwise contacting a surface of an article exposed to heat, comprising the steps of:
wrapping a heat-resistant flexible sheet around at least a portion of the article exposed to heat, the heat-resistant flexible sheet defining one or more notches; and
securing the heat-resistant flexible sheet around the at least a portion of the article exposed to heat by manually attaching interlocking fastening elements with complementary fastening elements.
